(19) United States
(12) Patent Application Publication
(10) Pub. No.: US 2010/0113993 A1
(43) Pub. Date: May 6, 2010

(54) FORCE-MULTIPLYING PERCUSSOR

(76) Inventors: James E.P. Davis, San Diego, CA (US); Susan B. Davis, San Diego, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/596,511

(22) PCT Filed: Jul. 10, 2007
(86) PCT No.: PCT/US07/15689

§ 371 Date: Oct. 19, 2009

(51) Int. Cl. A61H 23/02

(52) U.S. Cl. 601/108

(57) ABSTRACT

The invention is a percussor comprising an anvil, a hammer, a coil, and a pulse generator. The anvil is equipped with a force-receiving surface and a force-delivering surface which are rigidly connected together, the force-delivering surface being intended for contact with a patient's body. The hammer is also equipped with a force-receiving surface and a force-delivering surface, the hammer being attached to the anvil in such a way that the hammer's force-delivering surface and the anvil's force-receiving surface are mechanically free to come together or move apart. The coil forces the hammer's force-delivering surface and the the anvil's force-receiving surface to separate when the coil is energized with an electrical current. The pulse generator supplies repeated electrical current pulses to the coil which causes repeated impulse forces to be applied to a patient's body whenever the technician applies a continuing force to the hammer's force-receiving surface.

### CROSS-REFERENCES TO RELATED APPLICATIONS

(NOT APPLICABLE)

### STATEMENT REGARDING FEDERALLY-SPONSORED RESEARCH AND DEVELOPMENT

(NOT APPLICABLE)

### THE NAMES OF THE PARTIES TO A JOINT RESEARCH AGREEMENT

(NOT APPLICABLE)

### INCORPORATION BY REFERENCE OF MATERIAL SUBMITTED ON A COMPACT DISC

(NOT APPLICABLE)

### TECHNICAL FIELD

The field of the invention is percussors. A percussor is a medical device for supplying impulse forces to a patient's back or chest for the purpose of loosening and dislodging bronchial secretions in the lungs.

### BACKGROUND ART

The present invention is of a type of percussor based on the use of a solenoid in developing inpulse forces for application to a patient's back or chest. A “solenoid”, as defined in the McGRAW-HILL DICTIONARY OF SCIENTIFIC AND TECHNICAL TERMS, Fourth Edition, Sybil P. Parker, Editor in Chief, McGraw-Hill Book Company, New York, N.Y., 1989, is “a coil that surrounds a movable iron core which is pulled to a central position with reepect to the coil when the coil is energized by sending current through it.”

An example of this type of percussor is described in U.S. Pat. No. 4,512,339 as a device which energizes a coil to develop an impulse force for application to a patient and utilizes a compressed spring to return the movable iron core to its rest position. The designs of percussors of this type are unnecessarily complicated and inflexible with respect to their use in treating patients and the adjustment of the operating parameters of the devices.

The present invention avoids the complexities and inflexibilities of the prior art by utilizing a solenoid in a new and different way in generating impulse forces. The present invention utilizes the solenoid only for returning the movable iron core to its rest position. The patient-experienced impulse forces that result from the present invention are multiplied versions of the continuing force applied by a technician in using the invention.

### DISCLOSURE OF INVENTION

The invention is a force-multiplying percussor comprising an anvil, a hammer, a coil, and a pulse generator.

The anvil is equipped with a force-receiving surface and a force-delivering surface which are rigidly connected together, the force-delivering surface being intended for contact with a patient's body.

The hammer is also equipped with a force-receiving surface and a force-delivering surface, the hammer being attached to the anvil in such a way that the force-delivering surface of the hammer and the force receiving surface of the anvil are mechanically free to come together or move apart.

The coil forces the force-delivering surface of the hammer and the force-receiving surface of the anvil to separate when the solenoid is energized with an electrical current.

The pulse generator supplies repeated electrical current pulses to the coil which causes repeated force-multiplied impulse forces to be applied to a patient's body via the force-delivering surface of the anvil whenever the technician applies a continuing force to the force-receiving surface of the hammer.

### BRIEF DESCRIPTION OF DRAWINGS

FIG. 1 is a perspective view of a first embodiment of the invention.

FIG. 2 is a sectional view in a plane containing the axis of symmetry of the first embodiment of the invention shown in FIG. 1 with the hammer shown in an arbitrary position relative to the anvil.

FIG. 3 is a sectional view of the first embodiment similar to that of FIG. 2 except that the hammer is shown fully-withdrawn from contact with the anvil.

FIG. 4 is a perspective view of a second embodiment of the invention.

FIG. 5 is a sectional view in a plane containing the axis of symmetry of the second embodiment of the invention shown in FIG. 4 with the hammer shown in an arbitrary position relative to the anvil.

FIG. 6 is a sectional view of the second embodiment similar to that of FIG. 5 except that the hammer is shown in contact with the anvil.

FIG. 7 shows the inputs and outputs of the pulse generator which supplies the driving current for the invention.

### MODES FOR CARRYING OUT THE INVENTION

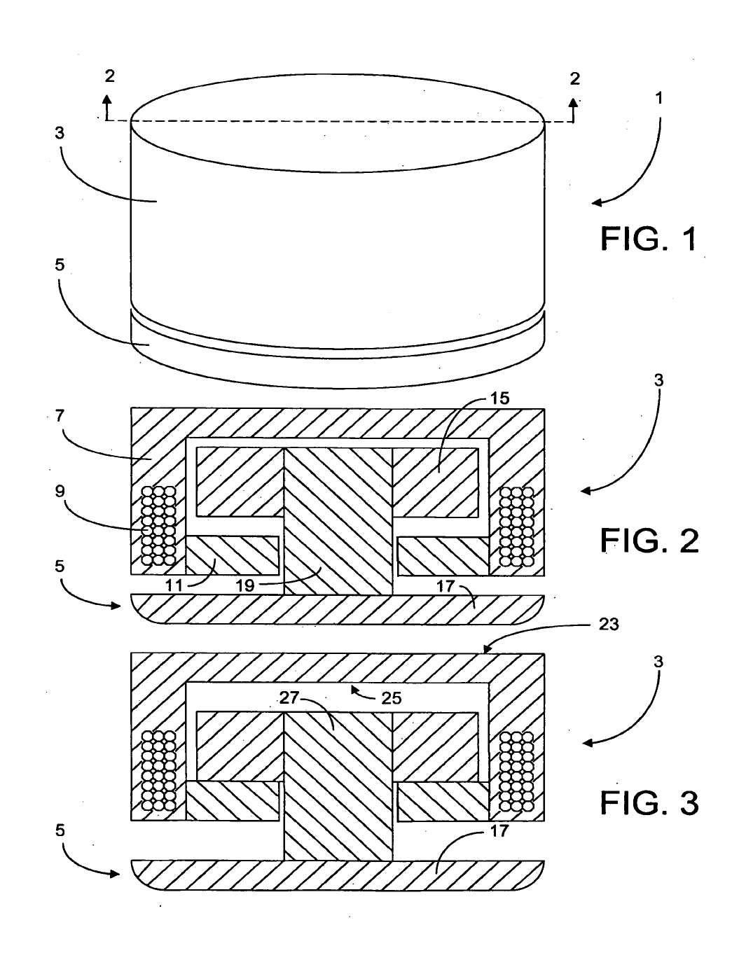

A first embodiment 1 of the invention is shown in FIG. 1. It consists of a hammer 3 and an anvil 5. The device is placed on the back or chest of a patient with the anvil in contact with the patient's body. The technician holds the device in place by gripping the hammer 3 with one hand, palm on top, and then turns on the power. The force continually applied by the technician to the hammer is converted by the device into repeated force-multiplied impulses in which the force associated with each impulse is significantly greater than the force being applied by the technician on a continuing basis.

The details of the device design are shown in the sectional view of FIG. 2. Hammer 3 consists of a plastic structural member 7 attached to guiding member 11. Guiding member 11 may be either metal or plastic and attaches to structural member 7 utilizing mating threaded regions. Coil 9 is embedded in structural member 7 as shown (assuming structural member 7 is a plastic material).

Anvil 5 consists of ring 15 and platen 17 connected together by cylindrical guiding member 19. Ring 15 has a rectangular cross-section and is made of a magnetic material such as iron. Guiding member 19 attaches to ring 15 by a press fit. Platen 17 is attached to guiding member 19 by means of a machine screw.

If there is no current flowing through coil 9, hammer 3 is free to slide back and forth along guiding member 19 subject only to the constraints imposed by the combination of structural member 7 and guiding member 11. Current flowing through coil 9 generates a magnetic field which exerts a force on ring 15 causing hammer 3 and anvil 5 to assume the relative positions shown in FIG. 3.

Let us now assume that a technican places the percussor against a sitting patient's back in the gentlest possiable way and coil 9 is energized by a series of current pulses. Hammer 3 and anvil 5 will assume the positions shown in FIG. 3 and remain in those positions for as long as the technician does not apply a force to force-receiving surface 23.

Now assume that the technician begins to apply a force to force-receiving surface 23 while the coil is energized with a current pulse. Nothing happens because the magnetic force holding hammer 3 and anvil 5 in the relative positions of FIG. 3 is greater than that applied by the technician.

When the current pulse ends, the magnetic force opposing the force applied by the technician disappears and the force-delivering surface 25 of hammer 3 strikes the force-receiving member 27 of anvil 5 thereby delivering a considerably greater force to platen 29 and the patient's back with which it is in contact. The process repeats with each current pulse supplied to coil 9.

The work expended by the technician is the product Fₜdₕ of the force Fₜ applied by the technician and the distance dₕ traveled by the hammer before striking the anvil. The technican's work is converted into kinetic energy of the hammer. This kinetic energy is disipated when the hammer strikes the anvil and the anvil depresses the patient's flesh. The kinetic energy is converted into potential energy associated with the depresseion of the patient's flesh and heat. The technician's work is balanced by the work Fₚdₚ expended by the patient's body which resists the anvil 5 with a force Fₚ over a distance dₚ. Thus, the effective force applied by the anvil to the patient's body is given by Fₚ=(dₕ/dₚ)Fₜ.

The quantity (dₕ/dₚ) is typically greater than three and consequently the percussor described herein typically has a force-multiplying effect. For example, a technician's force of 10 lbs is typically experienced as a force of 30 lbs or more by a patient.

A second embodiment 31 of the invention is shown in FIG. 2. It consists of a hammer 33 and an anvil 35. Like the first embodiment, the device is placed against the back or chest of a patient with the anvil in contact with the patient's body. The technician holds the device in place by gripping the hammer 33 with one hand, palm on top, and then turns on the power. The force continually applied by the technician to the hammer is converted by the device into repeated impulses in which the force associated with each impulse is significantly greater than the force being applied by the technician on a continuing basis.

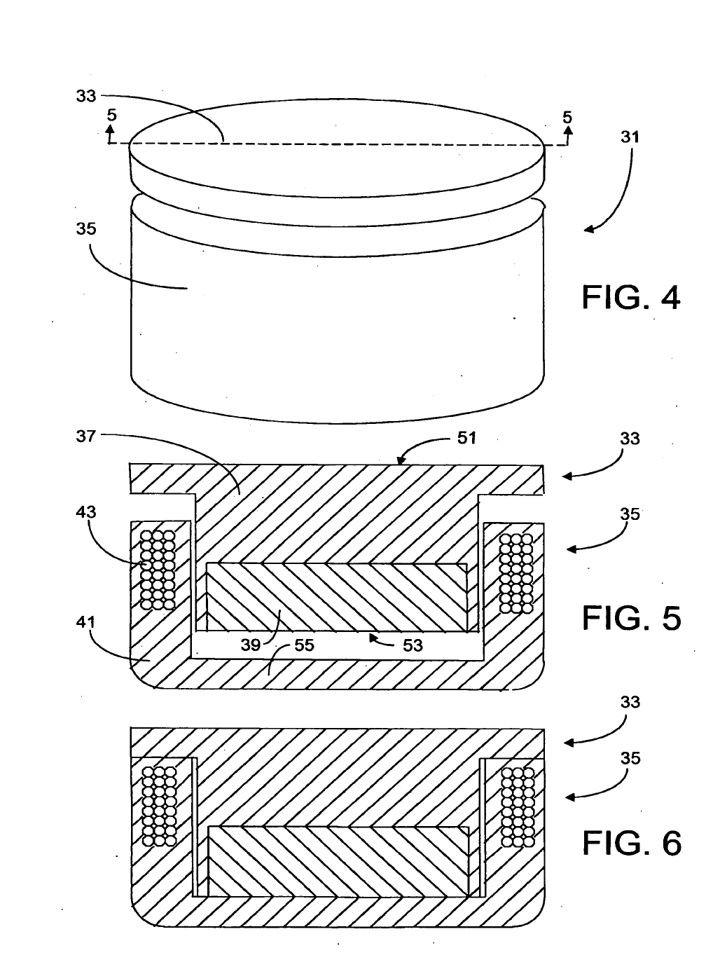

The design details for the second embodiment are shown in the sectional view of FIG. 5 taken in a plane containing the axis of symmetry of the device shown in FIG. 4.

Hammer 33 consists of a plastic body 37 in which is embedded a core 39 made of a magnetic material such as iron.

Anvil 35 consists of a plastic body 41 in which is embedded coil 43 which surrounds core 39 when hammer 33 is inserted into anvil 35.

Like the first embodiment, if there is no current flowing through coil 43, hammer 33 is free to slide back and forth within anvil 35 but limited in range by three pins anchored in the curved wall of anvil 35 and terminating in three vertical grooves spaced 120 degrees apart in hammer 33.

Current flowing through coil 43 generates a magnetic field which exerts a force on core 39 causing hammer 33 and anvil 35 to assume the positions shown in FIG. 5.

Let us again assume that a technican places the percussor against a sitting patient's back in the gentlest possiable way and coil 9 is energized by a series of current pulses. Hammer 33 and anvil 35 will assume the positions shown in FIG. 5 and remain in those positions for as long as the technician does not apply a force to force-receiving surface 51.

Again assume that the technician begins to apply a force to force-receiving surface 51 while the coil is energized with a current pulse. Nothing happens because the magnetic force holding hammer 33 and anvil 35 in the relative positions of FIG. 3 is greater than that applied by the technician.

When the current pulse ends, the magnetic force opposing the force applied by the technician disappears and the force-delivering surface 53 of hammer 33 strikes the force-receiving member 55 of anvil 35 as shown in FIG. 6. Hammer 33 thereby delivers a considerably greater force to the patient's back with which it is in contact, as discussed above.

For as long as the technician maintains a force on hammer 33, the process repeats with each current pulse supplied to coil 43.

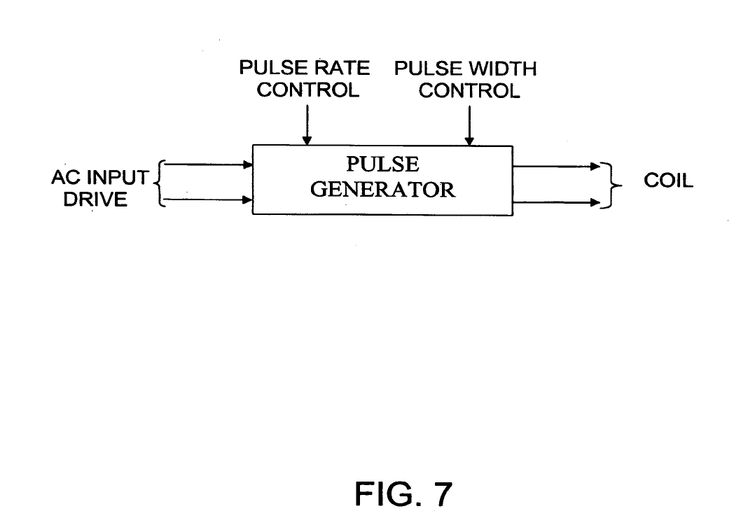

The pulse generator required to drive the percussor'c coil is shown in FIG. 7. It operates with standard 120 VAC input power and has means for controlling the widths and the repetition rate of the output pulses.

### INDUSTRIAL APPLICABILITY

The invention is a medical device for supplying impulse forces to a patient's back or chest for the purpose of loosening and dislodging bronchial secretions in the lungs, thereby having industrial applicability.

What is claimed is:

1. A percussor comprising:
an anvil having a force-receiving surface and a force-delivering surface which are rigidly connected together, the force-delivering surface being intended for contact with a patient's body;
a hammer having a force-receiving surface and a force-delivering surface, the hammer being attached to the anvil in such a way that the force-delivering surface of the hammer and the force receiving surface of the anvil are mechanically free to come together or move apart;
a coil which forces the force-delivering surface of the hammer and the force-receiving surface of the anvil to separate when the coil is energized with an electrical current;
a pulse generator which supplies repeated electrical current pulses to the coil.

2. The percussor of claim 1 wherein a force applied to the force-receiving surface of the hammer causes the force-delivering surface of the hammer to contact the force-receiving member of the anvil when the pulse generator is not supplying an electrical current pulse to the solenoid.

3. The percussor of claim 1 wherein a force applied to the force-receiving surface of the hammer does not cause the force-delivering surface of the hammer to contact the force-receiving member of the anvil when the pulse generator is supplying an electrical current pulse to the coil and the force applied is less than the maximum force for which the percussor is designed to handle.

4. The percussor of claim 1 wherein the coil is attached to the anvil.

5. The percussor of claim 1 wherein the coil is attached to the hammer.

6. The percussor of claim 1 wherein the anvil comprises a member made of a magnetic material.

7. The percussor of claim 1 wherein the hammer comprises a member made of a magnetic material.
